(19) United States
(12) Patent Application Publication
(10) Pub. No.: US 2023/0250278 A1
(43) Pub. Date: Aug. 10, 2023

(54) Polyisocyanurate Resin Foam Having High Compressive Strength, Low Thermal Conductivity, and High Surface Quality

(71) Applicant: BASF SE, Ludwigshafen am Rhein (DE)

(72) Inventors: Tobias KALUSCHKE, Lemfoerde (DE); Christian RENNER, Lemfoerde (DE); Olaf JACOBMEIER, Lemfoerde (DE); Sabrina KRONIG, Lemfoerde (DE)

(21) Appl. No.: 18/003,102

(22) PCT Filed: Jun. 23, 2021
(86) PCT No.: PCT/EP2021/067249

§ 371 Date: Dec. 22, 2022

(30) Foreign Application Priority Data
Jun. 25, 2020 (EP) 20182326.7

(51) Int. Cl. C08L 75/04; C08J 9/14

(52) U.S. Cl. CPC C08L 75/04; C08J 9/144; C08J 9/141; C08J 2203/14; C08L 2201/02; C08J 2375/04; C08J 2203/162

(57) ABSTRACT

Disclosed herein is a process for producing rigid polyisocyanurate foams, where (a) aromatic polyisocyanate, (b) isocyanate-reactive compounds including at least one polyetherol (b1) and/or polyesterol (b2), wherein where the number-average content of isocyanate-reactive hydrogen atoms of components (b 1) and (b2) is at least 1.7, (c) catalyst, (d) blowing agents, (e) flame retardants, (f) optionally auxiliary and additive substances and (g) optionally compounds having aliphatic hydrophobic groups and not falling under the definition of compounds (a) to (f) are mixed to afford a reaction mixture and allowed to cure to afford a rigid polyisocyanurate foam. Further disclosed herein is a rigid polyisocyanurate foam obtainable by the process.

Hard polyisocyanurate foam with high compressive strength, low thermal conductivity and high surface quality

The present invention relates to a process for the production of polyisocyanurate foams, in which (a) aromatic polyisocyanate, (b) isocyanate-reactive compounds containing at least one polyetherol (b1) and/or polyesterol (b2), wherein the number-average content of with isocyanate-reactive hydrogen atoms of component (b1) and (b2) is at least 1.7, (c) catalyst, (d) blowing agent, (e) flame retardant, (f) any auxiliaries and additives and (g) any compounds with aliphatic, hydrophobic groups that do not fall under the definition of compounds (a) to (f), mixed to form a reaction mixture and allowed to cure to form the rigid polyisocyanurate foam, blowing agent (d) being at least one aliphatic, halogenated hydrocarbon compound (d1), built up 2 to 5 carbon atoms, at least one hydrogen atom and at least one fluorine and/or chlorine atom and the compound (d1) has at least one Ko contains carbon double bond, and a hydrocarbon compound with 4 to 8 carbon atoms (d2) and the molar fraction of halogenated hydrocarbon compound (d1) between 20 and 60 mol % and the molar fraction of hydrocarbon compound (d2) between 40 and 80 mol-%, each based on the total content of the blowing agents (d1) and (d2), and the components (b) to (f) may contain compounds with aliphatic, hydrophobic groups and the content of aliphatic, hydrophobic groups, based on the The total weight of components (b) to (g) is at most 4.0% by weight and the reaction mixture is mixed at an isocyanate index of at least 240.

The present invention further relates to a rigid polyisocyanurate foam obtainable by a process according to the invention.

Rigid polyurethane foams or rigid polyisocyanurate foams are often used as insulating material for thermal insulation.

The foams are used in particular in composite elements with at least one cover layer. The production of composite elements, in particular from metal cover layers and a core of isocyanate-based foams, mostly polyurethane (PUR) or polyisocyanurate (PIR) foams, often also referred to as sandwich elements, on continuously operating double-belt systems is currently practiced on a large scale. In addition to sandwich elements for cold store insulation, elements for designing the facades of a wide variety of buildings or as roof elements are becoming increasingly important.

Essential requirements for rigid polyurethane or polyisocyanurate foams are low thermal conductivity, good mechanical properties and high flame retardancy

Behavior. The thermal insulation properties of closed-cell rigid foams depend on numerous factors, in particular the average cell size and the thermal conductivity of the cell gases. In the manufacture of sandwich elements, the foam surfaces, in particular the underside of the foam, should be as free as possible from imperfections.

In the past, chlorofluorocarbons (CFCs) were used in large quantities as physical blowing agents for the production of polyisocyanate-based rigid foams, particularly due to their very low thermal conductivity.

Their ozone-depleting effect (ODP: ozone depletion potential) within the stratosphere has been known for a long time, which is why the use of CFCs is no longer permitted by regulation. Hydrogenated chlorofluorocarbons (HCFCs), particularly R141b, initially appeared to be a promising alternative to CFCs, but this class of substances also has an ozone-depleting effect and their use has therefore been banned. Alternative blowing agents, which also have low thermal conductivity, such as hydrogenated fluorocarbons (HFCs), have almost no ozone-destroying effect, but are usually strong greenhouse gases and therefore have a high GWP value (GWP: green warming potential), which is why the use of HFCs as physical blowing agents in the production of rigid polyurethane or polyisocyanurate foams does not make sense.

Due to the disadvantages of CFCs and HFCs described above, hydrocarbons are often used today as physical blowing agents for the production of polyisocyanate-based rigid foams.

Pentane isomers, which are used particularly frequently as physical blowing agents in the continuous and discontinuous production of rigid foam composite elements, are of central importance here. For the continuous production of polyurethane or polyisocyanurate sandwich elements, the use of n-pentane as a physical blowing agent has become established over time, particularly for economic reasons.

In order to achieve improved processability of the polyurethane or polyisocyanurate reaction mixtures in combination with hydrocarbons, polyol components were developed which were obtained by incorporating hydrophobic compounds in polyol structures.

For example, EP 2804886 describes the incorporation of fatty acid structures in polyester polyols. These can, for example, pure fatty acids or fatty acid derivatives such. B. vegetable oils can be used as starting materials in the polyester or polyether polyol production. The fatty acid derivatives are incorporated into the resulting polyester polyols by means of a transesterification reaction during the polycondensation. Another option for hydro-Repellency of polyester polyols consists, for example, in the use of dimeric fatty acids as a building block for polyester synthesis (EP 3140333) or in the use of hydropho ben alkyl alcohols, such as. B. nonylphenol, or fatty alcohols and derivatives thereof. EP 2820059 describes the production of such polyether oils through the proportionate use of fatty acids or fatty acid derivatives in starter components which are used for alkoxylation. In addition to the incorporation of hydrophobic structures in polyols, the processability of hydrocarbon-driven polyurethane or polyisocyanurate-containing reaction mixtures can also be improved by the direct use of hydrophobic compounds such as e.g.

B. vegetable oils, fatty acids, fatty acid derivatives or fatty alcohols can be achieved in polyol components. For example, in EP 1023351 the additive use of hydrophobic compounds such. B. carboxylic acids (particularly fatty acids), carboxylic acid esters (particularly fatty acid esters) and alkyl alcohols (particularly fatty alcohols) in polyol resin mixtures for the manufacture of polyurethane- or polyisocyanurate-containing rigid foams are described. EP 3294786 describes, for example, the use of alkoxylated vegetable oils in polyol resin mixtures for the production of rigid foams. EP 0742241 describes the use of a hydrophobic compatibilizer such as e.g. B. nonylphenol, to improve the processability of hydrocarbon-blown polyol components.

By switching from n-pentane to the physical blowing agent cyclopentane, rigid foams with lower thermal conductivity can be produced from polyurethane or polyisocyanurate reaction mixtures, but the switch to cyclopentane also causes a severe deterioration in the mechanical foam properties, in particular the compressive strength and dimensional stability.

The switch from non-flammable CFCs and HFCs to flammable hydrocarbons requires a significant increase in the proportion of flame retardants within the reaction components in order to achieve comparably good fire resistance in rigid foams.

For ecotoxicological reasons, increasing the amounts of flame retardants is not desirable.

In a direct comparison with CFCs and HFCs, hydrocarbons also have significantly higher thermal conductivity values, which is why the sole use of hydrocarbons as physical blowing agents for the production of rigid foams with improved thermal insulation properties also does not make sense.

Non-combustible hydrofluoroolefins (HFOs), such as hydrofluoropropene or hydrochlorofluoropropene, are suitable candidates to replace HFCs, as they only have a very low ODP and GWP in addition to low thermal conductivity.

Their use in reac tion mixtures for the production of closed-cell polyurethane or polyisocyanurate Rigid foams are described in numerous patent publications. For example, the following documents may be mentioned: EP 2154223, EP 2739676, EP 2513023, US 20180264303, U.S. Pat. No. 9,738,768, US 2013/0149452, US 20150322225.

Among the HFO blowing agent compounds, the two substances 1-chloro-3,3,3-trifluoropropene [1233zd(E))] and 1,1,1,4,4,4-hexafluoro-2-butene [1336mzz (Z)] has gained important commercial importance within the last few years.

A disadvantage of these blowing agents is that they can severely reduce the storage stability of polyol components when stored with specific amine catalysts and silicone-containing foam stabilizers. In the production of continuous sandwich panels, the problem of storage stability can be avoided by e.g. B. either the amine catalysts, the foam stabilizers or the HFO blowing agents are metered as separate components into the reaction mixture. Another way of improving the storage stability is the use of special catalysts and special foam stabilizers.

In addition to the disadvantage of storage stability, it has been shown that the use of 1-chloro-3,3,3-trifluoropropene in particular causes the compressive strength of the foam to deteriorate, as is also the case with cyclopentane.

The use of excessive amounts of 1,1,1,4,4,4-hexafluoro-2-butene often leads to a reduction in foam quality below the cover layers, particularly in the continuous double-belt process.

WO2019096763 describes a polyurethane foam sandwich element for thermal insulation and a method for producing the sandwich element.

The blowing agent to produce the polyurethane foam includes cis-1,1,1,4,4,4-hexafluoro-2-butene (HF0-I336mzz-Z) and cyclopentane. The polyurethane foam composite panel according to the present invention exhibits both good insulating performance and mechanical strength. Isocyanurate foams, in particular foams with an isocyanate index of greater than 220, are not disclosed.

Examples 1 and 2 from WO2018218102 describe rigid polyurethane foams produced using potassium octoate (Dabco® K15), a flame retardant (TMCP) and a mixture of HFO-1336mzz(Z)(cis-1,1,1,4,4,4-hexafluoro-2-butene and cyclopentane in a molar ratio of 50:50 and

25:75. Stepanpol PS 2352 is used as the polyol, a hydrophobic polyesterol containing 7% by weight fatty acid and 2.5% by weight nonylphenol.

It is also known that polyisocyanurate foams are more flame-resistant than polyurethane foams.

In sample 3 from example 2, WO2016184433 describes the production of a polyurethane foam using potassium octoate, a flame retardant and a mixture of HCFO-1233zd and cyclopentane in a molar ratio of approx. 35:65. The sugar-based polyetherol GR 835G from Sinopec with an OH number of 450 mg KOH/g is used as the polyol. This results in an isocyanate index of 210.

The object of the invention was therefore to improve the profile of properties from the aforementioned properties and, in particular, to develop a new process which can be used for the manufacture of rigid polyisocyanurate foams and enables the production of optimized rigid foams with high flame resistance and significantly reduced thermal conductivity , which, despite improved thermal insulation properties, have very good mechanical compressive strength.

It was also the task to develop such a process that is suitable for the production of polyisocyanurate sandwich elements, in particular in a continuous production process, and which leads to sandwich elements with very low thermal conductivity, high compressive strength and high flame resistance, which have excellent foam surface qualities, especially towards the lower top layer.

This object is achieved by a process for the production of polyisocyanurate foams, in which (a) aromatic polyisocyanate, (b) isocyanate-reactive compounds containing at least one polyetherol (b1) and/or polyesterol (b2), wherein the number-average content of isocyanate-reactive hydrogen atoms in components (b1) and (b2) is at least 1.7, (c) catalyst, (d) blowing agent, (e) flame retardant, (f) any auxiliaries and additives and (g) any compounds mixed with aliphatic, hydrophobic groups that do not fall under the definition of compounds (a) to (f) to form a reaction mixture and allowed to cure to form the polyisocyanate-based rigid foam, with blowing agent (d) containing at least one aliphatic, halogenated hydrocarbon compound (d1) composed of 2 to 5 carbon atoms, at least one hydrogen atom and at least one fluorine and/or chlorine atom and the compound (d1) has at least contains at least one carbon-carbon double bond, and contains a hydrocarbon compound with 4 to 8 carbon atoms (d2) and the molar fraction of halogenated hydrocarbon compound (d1) is between 20 and 60 mol % and the molar fraction of hydrocarbon compound (d2) is between 40 and 80 mol %, based in each case on the total content of the blowing agents (d1) and (d2), and the components (b) to (f) may contain compounds with aliphatic, hydrophobic groups and the content of aliphatic, hydrophobic groups pen, based on the total weight of components (b) to (g), at most 4.0% by weight

contributes and the mixing to form the reaction mixture takes place at an isocyanate index of at least 240. The present invention further relates to a polyisocyanurate rigid foam obtainable by a process according to the invention.

A rigid polyisocyanurate foam is generally understood to mean a foam which contains both urethane and isocyanurate groups.

In connection with the invention, the term rigid polyurethane foam is also intended to include rigid polyisocyanurate foam, the production of polyisocyanurate foams being based on an isocyanate index of at least 180. The isocyanate index is the ratio of isocyanate groups to isocyanate-reactive groups, multiplied by 100. An isocyanate index of 100 corresponds to an equimolar ratio of the isocyanate groups used in component (a) to the isocyanate-reactive groups in components (b) to (g).

Rigid polyisocyanurate foams according to the present invention have a compressive stress at 10% compression of greater than or equal to 80 kPa, preferably greater than or equal to 120 kPa, particularly preferably greater than or equal to 140 kPa.

Furthermore, according to DIN ISO 4590, the isocyanate-based rigid foam according to the invention has a closed cell content of greater than 80%, preferably greater than 90%. Further details on polyisocyanurate hard foams according to the invention can be found in “Plastics Handbook, Volume 7, Polyurethane”, Carl Hanser Verlag, 3. Edition 1993, Chapter 6, especially Chapters 6.2.2 and 6.5.2.2.

It is essential to the invention that components (b) to (g) contain 0 to a maximum of 4.0% by weight, i.e. 0 to 4% by weight, preferably from 0 to 3.5% by weight and in particular 0 1 to 3.0% by weight of aliphatic hydrophobic groups, based on the total weight of components (b) to (g).

In the context of the present invention, a hydrophobic group is understood as meaning an aliphatic hydrocarbon group having preferably more than 6, particularly preferably more than 8 and less than 100 and in particular at least 10 and at most 50 directly adjacent carbon atoms. The adjacent carbon atoms can be connected not only by carbon-carbon single bonds but also by carbon-carbon double bonds. The carbon atoms of the hydrophobic group are connected directly to one another and are not interrupted, for example, by heteroatoms. In contrast, hydrogen atoms of the hydrocarbons can be substituted, for example by halogen atoms, OH groups or carboxylic acid groups. The hydrocarbons of the hydrophobic groups according to the invention are preferably unsubstituted.

If compounds with hydrophobic groups are used, these can be part of one of the compounds (b) to (f) or as separate compounds (g) containing hydrophobic groups.

ten, to be used. Only the weight of the hydrophobic group is used to calculate the proportion of hydrophobic groups, and any substituents that are different from hydrogen, such as OH groups or halogen groups, are not taken into account when calculating the proportion.

The polyisocyanates (a) are the aromatic polyfunctional isocyanates known in the art.

Such polyfunctional isocyanates are known and can be prepared using methods known per se. The polyfunctional isocyanates can also be used in particular as mixtures, so that component (a) in this case contains various polyfunctional isocyanates. Polyisocyanate (a) is a polyfunctional isocyanate having two (hereinafter also referred to as diisocyanates) or more than two isocyanate groups per molecule.

In particular, the isocyanates (a) are selected from the group consisting of aromatic polyisocyanates, such as 2,4- and 2,6-toluene diisocyanate and the corresponding isomer mixtures, 4,4′-, 2,4′- and 2, Mixtures of 2′-diphenylmethane diisocyanate and the corresponding isomers, mixtures of 4,4′- and 2,4′-diphenylmethane diisocyanates, polyphenylpolymethylene polyisocyanates, mixtures of 4,4′-, 2,4′- and 2,2′-Diphenylmethane diisocyanates and polyphenylpolyethylene polyisocyanates (crude MDI) and mixtures of crude MDI and toluene diisocyanates.

Particularly suitable are 2,2′-, 2,4′- or 4,4′-diphenylmethane diisocyanate (MDI) and mixtures of two or three of these isomers, 1,5-naphthylene diisocyanate (NDI), 2,4- and/or 2,6-toluene diisocyanate (TDI), 3,3′-dimethyldiphenyl diisocyanate, 1,2-diphenylethane diisocyanate and/or p-phenylene diisocyanate (PPDI).

Modified polyisocyanates, i.

Products obtained by the chemical reaction of organic polyisocyanates and containing at least two reactive isocyanate groups per molecule are used.

Particular mention is made of polyisocyanates containing ester, urea, biuret, allophanate, carbodiimide, isocyanurate, uretdione, carbamate and/or urethane groups, often together with unreacted polyisocyanates.

The polyisocyanates of component (a) particularly preferably contain 2,2′-MDI or 2,4′-MDI or 4,4′-MDI or mixtures of at least two of these isocyanates (also called monomeric diphenylmethane or MMDI) or oligomeric MDI, the consists of higher homologues of MDI which have at least 3 aromatic nuclei and a functionality of at least 3, or mixtures of two or more of the above-mentioned diphenylmethanediisocyanate or crude MDI obtained in the production of MDI, or preferably mixtures of at least one oligomer of MDI and at least one of the abovementioned low molecular weight MDI derivatives 2,2′-MDI, 2,4′-MDI or 4,4′-MDI (also called polymeric MDI).

As a rule, the isomers and homologues of MDI are obtained by distillation of crude MDI.

In addition to the dinuclear MDI (MMDI), polymeric MDI preferably contains one or more polynuclear condensation products of MDI with a functionality of more than 2, in particular 3 or 4 or 5.

Polymeric MDI is known and is often referred to as polyphenyl polymethylene polyisocyanate.

The mean (average) functionality of a polyisocyanate containing polymeric MDI can vary in the range from about 2.2 to about 4, more preferably from 2.4 to 3.8, and especially from 2.6 to 3.0.

Such a mixture of polyfunctional isocyanates based on MDI with different functionalities is, in particular, the crude MDI obtained as an intermediate product in the production of MDI.

Polyfunctional isocyanates or mixtures of two or more polyfunctional isocyanates based on MDI are known and are commercially available from BASF Polyurethanes GmbH under the trade names Lupranat® M20, Lupranat® M50, or Lupranat® M70.

Component (a) preferably contains at least 70%, particularly preferably at least 90% and in particular 100% by weight, based on the total weight of component (a), of one or more isocyanates selected from the group consisting of 2,2′-MDI, 2,4′-MDI, 4,4′-MDI and oligomers of MDI. The content of oligomeric MDI is preferably at least 20 percent by weight, particularly preferably more than 30 to less than 80 percent by weight, based on the total weight of component (a).

The viscosity of component (a) used can vary within a wide range.

Component (a) preferably has a viscosity of 100 to 3000 mPa*s, particularly preferably 100 to 1000 mPa*s, particularly preferably 100 to 800 mP*s, particularly preferably 200 to 700 mPa*s and especially preferably from 400 to 650 mP*s at 25° C. The viscosity of component (a) can vary within a wide range.

Compounds (b) which are reactive toward isocyanate groups can be any compounds known in polyurethane chemistry that have groups that are reactive toward isocyanate groups, preferably compounds containing at least one hydroxyl group, —NH group, or

Nhh group or carboxylic acid group, preferably with at least one NH2 or OH group and in particular at least one —OH group.

The functionality towards isocyanate groups can be in the range from 1 to 8, preferably from 2 to 8.

The compounds which are reactive toward isocyanate groups include polyether polyols (b1), polyester polyols (b2) or mixtures thereof, preferably polyester oils (b2) or mixtures of polyether oils (b1) and polyester oils (b2). Polyether oils (b1) and polyester oils (b2) preferably have a number-average molecular weight of 150 to 15 000 g/mol, preferably 150 to 5 000 g/mol and particularly preferably 200 to 2 000 g/mol. In addition to polyether oils and polyester oils, it is also possible, for example, to use low molecular weight chain extenders and/or crosslinking agents known in polyurethane chemistry. The compounds (b) preferably have a number-average molecular weight of from 62 to 15,000 g/mol. The compounds (b) preferably have a number-average functionality of at least 1.7, particularly preferably at least 2. According to the invention, the polyether oils (b1) and/or polyester oils (b2) have a number-average functionality of at least 1.7, more preferably at least 2.0.

Polyether oils (b1) are produced, for example, from epoxides, such as propylene oxide and/or ethylene oxide, or from tetrahydrofuran with hydrogen-active starter compounds, such as aliphatic alcohols, phenols, amines, carboxylic acids, water or compounds based on natural materials, such as sucrose, sorbitol or mannitol use of a catalyst.

Mentionable here are basic catalysts or double metal cyanide catalysts, as described, for example, in PCT/EP2005/010124, EP 90444 or WO 05/090440.

Polyesteroie (b2) z.

B. prepared from aliphatic or aromatic dicarboxylic acids and polyhydric alcohols, polythioether polyols, polyesteramides, hydroxyl-containing polyacetals and/or hydroxyl-containing aliphatic polycarbonates, preferably in the presence of an esterification catalyst. Other possible polyols are, for example, in “Plastics Manual, Volume 7, Polyurethane”, Carl Hanser Verlag, 3. Edition 1993, Chapter 3.1 specified.

According to the invention, the compounds (b) reactive toward isocyanate groups contain a polyether polyol (b1) and/or a polyester polyol (b2), preferably a polyester polyol (b2), optionally in combination with a polyether polyol (b1).

The proportion by weight of polyetherol (b1) is preferably 0 to 30% by weight, particularly preferably 0 to 20% by weight and in particular 1 to 15% by weight, and of polyesterol (b2) is preferably 70 to 100, particularly preferably 80 to 100 and in particular 85 to 99% by weight, based in each case on the total weight of polyetherol (b1) and polyesterol (b2). It is within the scope of the present disclosure the terms “polyesterpolyol” and “polyesterol” are synonymous, as are the terms “polyetherpolyol” and “polyetherol”.

The polyether oils (b1) are prepared by known methods, for example by anionic polymerization of alkylene oxides with the addition of at least one starter molecule containing 1 to 8, preferably 2 to 6, reactive hydrogen atoms bonded, or a starter molecule mixture which, averaged over all starters 1 present, 5 to 8, preferably 2 to 6 reactive hydrogen atoms bonded in the presence of catalysts.

If mixtures of starter molecules with different functionality are used, fractional functionalities can be obtained. Influences on the functionality, for example due to side reactions, are not taken into account in the nominal functionality. Alkali metal hydroxides, such as sodium or potassium hydroxide, or alkali metal alkoxides, such as sodium methylate, sodium or potassium ethylate or potassium isopropylate, or Lewis acids, such as antimony pentachloride, boron trifluoride etherate or fuller's earth, can be used as catalysts. Aminic alkoxylation catalysts such as dimethylethanolamine (DMEOA), imidazole and imidazole derivatives can also be used. Furthermore, double metal cyanide compounds, so-called DMC catalysts, can also be used as catalysts.

The alkylene oxides used are preferably one or more compounds having 2 to 4 carbon atoms in the alkylene radical, such as tetrahydrofuran, 1,2-propylene oxide, ethylene oxide, 1,2- or ,3- Butylene oxide, each used alone or in the form of mixtures.

Preference is given to using ethylene oxide and/or 1,2-propylene oxide, particularly preferably ethylene oxide.

The starter molecules are compounds containing hydroxyl groups or amine groups, for example ethylene glycol, diethylene glycol, triethylene glycol, 1,2-propanediol, 1,3-propanediol, bisphenol A, bisphenol F, glycerol, trimethylolpropane, pentaerythritol, sugar derivatives such as sucrose, hexitol derivatives, such as sorbitol, methylamine, ethylamine, isopropylamine, butylamine, benzylamine, aniline, toluidine, toluenediamine (TDA), naphthylamine, ethylenediamine, methylenedianiline, 2,2-diaminodiphenylmethane (2,2-MDA) 2,4′-diaminodiphenylmethane (2,4-MDA), 4,4′-diaminodiphenylmethane (4,4-MDA), diethylenetriamine, 4,4′-methylenedianiline, 1,3′-propanediamine, 1,6-hexanediamine, ethanolamine, diethanolamine, triethanolamine and other two or polyvalent alcohols or one or polyvalent amines or water.

Since the highly functional compounds are often in solid form under the usual alkoxylation reaction conditions, it is generally customary to alkoxylate them together with co-initiators. Suitable co-initiators are, for. B. water, polyfunctional lower alcohols, z. B. glycerin, trimethylolpropane, pentaerythritol, diethylene glycol, ethylene glycol, propylene glycol and their Ho-mole. Examples of other possible co-initiators are: organic fatty acids or monofunctional fatty alcohols, fatty acid monoesters or fatty acid methyl esters, e.g. B. oleic acid, stearic acid, oleic acid methyl ester, stearic acid methyl ester or biodiesel, which serve to improve the solubility of the blowing agent in the production of polyisocyanurate rigid foams.

Preferred starter molecules for producing the polyether polyols (b1) are sorbitol, sucrose, ethylenediamine, TDA, trimethylolpropane, pentaerythritol, glycerol, biodiesel, nonylphenol, ethylene glycol and diethylene glycol.

More preferred starter molecules are all starters or starter mixtures with an average total functionality of <3, particularly preferred glycerol, trimethylolpropane, biodiesel, nonylphenol, ethylene glycol, diethylene glycol, propylene glycol and bisphenol A, especially ethylene glycol, diethylene glycol and glycerol.

The polyether polyols used as part of component (b1) preferably have an average functionality of from 1.5 to 6 and in particular from 2.0 to 4.0 and number-average molecular weights of preferably from 150 to 3000, particularly preferably from 150 to 1500 and in particular from 250 to 800 g/mol.

The OH number of the polyether polyols of component (b1) is preferably from 1200 to 50, preferably from 600 to 100 and in particular from 300 to 150 mg KOH/g.

Suitable polyester polyols (b2) can be produced from organic dicarboxylic acids having 2 to 12 carbon atoms, preferably aromatic, or mixtures of aromatic and aliphatic dicarboxylic acids and polyhydric alcohols, preferably diols, having 2 to 12 carbon atoms, preferably 2 to 6 carbon atoms.

Particularly suitable dicarboxylic acids are: succinic acid, glutaric acid, adipic acid, suberic acid, azelaic acid, sebacic acid, decanedioic acid, maleic acid, fumaric acid, phthalic acid, isophthalic acid and terephthalic acid.

The dicarboxylic acids can be used either individually or as a mixture.

Instead of the free dicarboxylic acids, the corresponding dicarboxylic acid derivatives, such as. B. dicarboxylic acid esters of alcohols having 1 to 4 carbon atoms or dicarboxylic acid anhydrides can be used. Phthalic acid, phthalic anhydride, terephthalic acid and/or isophthalic acid are preferably used as a mixture or alone as aromatic dicarboxylic acids or acid derivatives. The aliphatic dicarboxylic acids used are preferably dicarboxylic acid mixtures of succinic, glutaric and adipic acid in proportions of, for example, 20 to 35:35 to 50:20 to 32 parts by weight, and in particular adipic acid. Particularly preferred are used as Poly esteroie (b2) exclusively those that use only aromatic shear dicarboxylic acid or derivatives thereof are obtained. At least one compound selected from the group consisting of terephthalic acid, dimethyl terephthalate (DMT), polyethylene terephthalate (PET), phthalic acid, phthalic anhydride (PSA) and isophthalic acid is preferably used as the aromatic dicarboxylic acid, particularly preferably at least one compound from the group consisting of terephthalic acid, dimethyl terephthalate (DMT), polyethylene terephthalate (PET) and phthalic anhydride (PSA) and in particular of phthalic acid and/or phthalic anhydride.

Examples of dihydric and polyhydric alcohols, in particular diols, are: monoethylene glycol, diethylene glycol, triethylene glycol, polyethylene glycol, 1,2- or

1,3-propanediol, dipropylene glycol, polyopropylene glycol, 1,4-butanediol, 1,5-pentanediol, 1,6-hexanediol, 1,10-decanediol, glycerol, trimethylolpropane and pentaerythritol, and alkoxylates of the same starters. Monoethylene glycol, diethylene glycol, triethylene glycol, 1,2- or 1,3-propanediol, dipropylene glycol and ethoxylates of the same starters, for example ethoxylated glycerol, or mixtures of at least one of the diols mentioned. Monoethylene glycol, diethylene glycol, glycerol and ethoxylates of the same starters, or mixtures of at least two of the diols mentioned, in particular diethylene glycol, are used in particular. Polyester polyols from lactones, e.g. B. e-caprolactone or hydroxycarboxylic acids, z. B. w-hydroxycaproic acid.

To prepare the polyester polyols (b2), the aliphatic and aromatic polycarboxylic acids and/or derivatives and polyhydric alcohols can be esterified without a catalyst or preferably in the presence of esterification catalysts, expediently in an atmosphere of inert gas such as nitrogen in the melt at temperatures of 150 to 280° C. , Preferably 180 to 260° C., optionally under reduced pressure to the desired acid number, which is less than 10, preferably less than 2 geous, are polycondensed.

Examples of suitable esterification catalysts are iron, cadmium, cobalt, lead, zinc, antimony, magnesium, titanium and tin catalysts in the form of metals, metal oxides or metal salts. However, the polycondensation can also be carried out in the liquid phase in the presence of diluents and/or entrainers, such as e.g. B. benzene, toluene, xylene or chlorobenzene, are carried out for azeotropic distillation of the water of condensation.

To prepare the polyester polyols (b2), the organic polycarboxylic acids and/or derivatives and polyhydric alcohols are advantageously used in a molar ratio of 1:1 to 2.2, preferably 1:1.05 to 2.1 and particularly preferably 1:1.1 up to 2.0 polycondensed.

The polyester polyols (b2) obtained generally have a number-average molecular weight of from 200 to 3000, preferably from 300 to 1000 and in particular from 400 to 800.

If component (b) contains compounds with hydrophobic groups, the compounds have at least one hydrophobic group as well as at least one isocyanate-reactive group, for example an acid group, an amino group or a hydroxyl group.

These constituents can be the polyether oil (b1) or the polyester oil (b2), but alternatively or additionally separate compounds can also be used which have both one or more isocyanate-reactive groups and one or more hydrophobic groups. If the hydrophobic groups are part of the polyether oils (b1) or polyester oils (b2), they can be incorporated into the polyols (b1) or (b2) via known reactions, such as esterification, transesterification or alkoxylation. The starting compounds with hydrophobic groups that are incorporated into polyols (b1) or (b2) generally have at least one group that can be esterified, transesterified, or alkoxylated, such as a carboxylic acid group, a carboxylic acid ester group, a carboxamide group, a carboxylic acid anhydride group, a hydroxyl group, or a primary or secondary amino group.

Compounds with hydrophobic groups of component (b) which do not fall under the definition of polyether oils (b1) or polyester oils (b2) are, for example, hydroxyl-functional hydrophobic substances such as alkyl alcohols, fatty alcohols or hydroxyl-functionalized oleochemical compounds.

Examples of such alkyl alcohols and fatty alcohols are octyl, nonyl, decyl, undecyl, dodecyl, oleyl, cetyl, isodecyl, tridecyl, lauryl and mixed C12-C14 alcohols, 2-ethylhexanol, alkylphenols with >6 carbon atoms in the alkyl radical , such as B. Nonylphenol, oxo alcohols with >6 carbon atoms, which can be obtained by hydroformylation of α-olefins and other reactions, Guerbet alcohols with >6 carbon atoms, and mixtures of different alkyl and fatty alcohols.

If hydroxy-functional compounds with hydrophobic groups are used, the following are preferably used: castor oil, Turkish red oil, oils modified with hydroxyl groups such as grape seed oil, black cumin oil, pumpkin seed oil, borage seed oil, soybean oil, wheat germ oil, rapeseed oil, sunflower oil, peanut oil, apricot kernel oil, pistachio kernel oil, almond oil, olive oil, macadamia nut oil, Avocado oil, sea buckthorn oil, sesame oil, hazelnut oil, evening primrose oil, wild rose oil, hemp oil, safflower oil, walnut oil, fatty acid esters modified with hydroxyl groups based on myristoleic acid, palmitoleic acid, oleic acid, vaccenic acid, petroselinic acid, gadoleic acid, erucic acid, nervonic acid, linoleic acid, linolenic acid, stearidonic acid, arachidonic acid, timnodonic acid, clupanodonic acid, cervonic acid or mixtures of at least two of these compounds.

Another group of hydroxy-functionalized oleochemical compounds can be obtained by ring opening of epoxidized fatty acid esters with simultaneous reaction with alcohols and, if appropriate, subsequent further transesterification reactions.

Hydroxyl groups are mainly incorporated into oils and fats by epoxidation of the olefinic double bond contained in these products, followed by reaction of the epoxide groups formed with a monohydric or polyhydric alcohol. The epoxide ring becomes a hydroxyl group or, in the case of polyfunctional alcohols, a structure with a higher number of OH groups. Since oils and fats are mostly glycerol esters, parallel transesterification reactions take place in the above reactions. The compounds obtained in this way preferably have a molecular weight in the range between 500 and 1500 g/mol.

Compounds (b) which contain hydrophobic groups and which contain amine groups are preferably understood to mean the compounds which have between 7 and 40 carbon atoms.

Examples include the fatty alkanolamines such as decylamine, dodecylamine, tetradecylamine and hexadecylamine.

Examples of alkanolam ides that can be used are fatty alkanolam ides, e.g.

B. fatty acid diethanolamide, lauric acid diethanolamide and oleic acid monoethanolamide can be used.

As described, compounds (b) containing hydrophobic groups can also be understood as connec tions which contain at least one carboxylic acid group, such as, for example, mono- or bifunctional carboxylic acids, e.g.

B. with 7-40 carbon atoms per molecule. Examples which may be mentioned are: dimeric fatty acids or, preferably, fatty acids. Examples of fatty acids are caproic acid, caprylic acid, capric acid, lauric acid, myristic acid, palmitic acid, stearic acid, oleic acid, linoleic acid, linolenic acid, ricinoleic acid and mixtures thereof. The acids can have either a biological or a petrochemical origin. An example of a suitable petrochemical acid is z. B. 2-ethylhexanoic acid.

It is further preferred that the hydroxy-functionalized oleochemical compound, if present, is a polyesterol with a hydrophobic group (b2a).

To prepare the polyester polyols (b2a) with a hydrophobic group, hydrophobic starting compounds are preferably fatty acids, fatty acid derivatives or alkylphenol alkoxylates having >8 carbon atoms in the alkyl group. The polyester polyols (b2) preferably contain at least one polyesterol (b2a) which is obtainable by esterifying

(b2a1) 10 to 80 mol % of a dicarboxylic acid composition containing

(b2a11) 20 to 100 mol %, based on the dicarboxylic acid composition, of one or more aromatic dicarboxylic acids or derivatives thereof,

(b2a12) 0 to 80 mol %, based on the dicarboxylic acid composition, of one or more aliphatic dicarboxylic acids or derivatives thereof,

(b2a2) 0 to 30 mol % of one or more fatty acids and/or fatty acid derivatives,

(b2a3) 2 to 70 mol % of one or more aliphatic or cycloaliphatic diols having 2 to 18 carbon atoms or alkoxylates thereof,

b2a4) 0 to 80 mol % of an alkoxylation product of at least one starter molecule having an average functionality of at least two, based in each case on the total amount of components (b2a1) to (b2a4), the components (b2a1) to (b2a4) making up 100 Add mol %.

A polyester polyol of component (b2) preferably has a number-weighted average functionality of greater than or equal to 1.7, preferably greater than or equal to 1.8, particularly preferably greater than or equal to 2.0 and in particular greater than 2.2, which leads to a higher crosslinking density of the polyurethane produced therewith and thus to better mechanical properties of the polyurethane foam.

Furthermore, component (b) can contain chain extenders and/or crosslinking agents, for example to modify the mechanical properties, e.g.

B. the hardness.

Diols and/or triols and also amino alcohols with molecular weights of less than 150 g/mol, preferably from 60 to 130 g/mol, are used as chain extenders and/or crosslinking agents.

Consider, for example, aliphatic, cycloaliphatic and/or araliphatic diols having 2 to 8, preferably 2 to 6 carbon atoms, such as.

ethylene glycol, 1,2-propylene glycol, diethylene glycol, dipropylene glycol, 1,3-propanediol, 1,4-butanediol, 1,6-hexanediol, o-, m-, p-dihydroxycyclohexane, bis-(2-hydroxy-ethyl)-hydroquinone.

Also suitable are aliphatic and cycloaliphatic triols such as glycerol, trimethylolpropane and 1,2,4- and 1,3,5-trihydroxycyclohexane.

If chain extenders, crosslinking agents or mixtures thereof are used to produce the rigid polyurethane foams, these are advantageously used in an amount of from 0 to 15% by weight, preferably from 0 to 5% by weight, based on the total weight of component (b) used.

Component (b) preferably contains less than 10% by weight and more preferably less than 7% by weight and in particular less than 5% by weight of chain extenders and/or crosslinking agents.

Catalysts (c) for producing the polyurethane foams are, in particular, compounds which greatly accelerate the reaction of the compounds of components (b) to (g) containing reactive hydrogen atoms, in particular hydroxyl groups, with the polyisocyanates (a).

Basic polyurethane catalysts are expediently used, for example tertiary amines such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl or

N-Ethylmorpholine, N-Cyclohexylmorpholine, N,N,N′,N′-Tetramethyl-ethylenediamine,

N,N,N,N-Tetramethylbutanediamine, N,N,N,N-Tetramethylhexane-1,6, Pentamethyldiethylenetriamine, Bis(2-dimethylaminoethyl) ether, dimethylpiperazine, N-dimethylaminoethylpiperidine, 1,2-dimethylimidazole, 1-azabicyclo-(2,2,0)-octane, 1,4.

Diazabicyclo-(2,2,2)-octane (Dabco) and alkanolamine compounds such as triethanolamine, triisopropanolamine, N-methyl- and N-ethyldiethanolamine, dimethylaminoethanol, 2-(N,N-dimethylamino-ethoxy)ethanol, N,N″N′-tris-(dialkylaminoalkyl)hexahydrotriazines, e.g.

B. N,N′,N″-Tris-(dimethylaminopropyl)-s-hexahydrotriazine, and triethylenediamine.

However, metal salts such as iron(II) chloride, zinc chloride, lead octoate and tin salts such as tin dioctoate, tin diethylhexoate and dibutyltin dilaurate and mixtures of tertiary amines and organic tin salts are also suitable.

Other suitable catalysts are: amidines, such as 2,3-dimethyl-3,4,5,6-tetrahydropyrimidine, tetraalkylammonium hydroxides, such as tetramethylammonium hydroxide, alkali metal hydroxides, such as sodium hydroxide, and alkali metal alkoxides, such as sodium methoxide and potassium isopropylate, alkali metal carboxylates and alkali metal salts of long-chain fatty acids with 8 to 20 carbon atoms and, where appropriate, lateral OH groups.

Also suitable as catalysts are amines that can be incorporated, i.e. preferably amines with an OH, NH or NH2 function, such as ethylenediamine, triethanolamine, diethanolamine, ethanolamine and dim ethylethanolamine.

Catalysts which can be installed can be regarded as both component (c) and component (b) compounds.

Preferably used are 0.001 to 10 parts by weight of catalyst or

Catalyst combination, based on 100 parts by weight of component (b).

It is also possible to run the reactions without catalysis. In this case, the catalytic activity of amine-initiated polyols is usually utilized. In addition, suitable catalysts for the trimerization reaction of the excess NCO groups with one another are: catalysts which form isocyanurate groups, for example ammonium ion or alkali metal salts, especially ammonium or alkali metal carboxylates, alone or in combination with tertiary amines. Isocyanurate formation leads to flame-retardant PIR foams, which are preferably used in technical rigid foam, for example in construction as insulating boards or sandwich elements.

In a preferred embodiment, the catalyst (c) contains a tertiary amine catalyst and an ammonium or alkali metal carboxylate catalyst.

In a particularly preferred embodiment, catalyst (c) contains at least one amine catalyst selected from the group consisting of pentamethyldiethylenetriamine and bis(2-dimethylaminoethyl)ether and at least one alkali metal carboxylate catalyst selected from the group consisting of potassium formate, potassium acetate and potassium-2-Ethyl hexanoate. Surprisingly, the use of these catalysts in the continuous production of sandwich elements, for example in a double belt, leads to sandwich elements which have a particularly smooth foam surface for the cover layer, in particular for the lower cover layer. This results in sandwich panels with excellent adhesion of the foam to the skin and flawless surfaces.

According to the invention, the blowing agent (d) used is a blowing agent mixture which comprises at least one aliphatic, halogenated hydrocarbon compound (d1) composed of 2 to 5 carbon atoms, at least one hydrogen atom and at least one fluorine and/or chlorine atom and a hydrocarbon compound having 4 to 8 carbon atoms (d2) and wherein the compound (d1) contains at least one carbon-carbon double bond.

Suitable compounds (d1) include trifluoropropenes and tetrafluoropropenes such as (HFO-1234), pentafluoropropenes such as (HFO-1225), chlorotrifluoropropenes such as (HFO-1233), chlorodifluoropropenes, chlorotetrafluoropropenes and hexafluorobutenes, and mixtures of one or more these components.

Tetrafluoropropenes, pentafluoropropenes, chlorotrifluoropropenes and hexafluorobutenes are preferred, where the unsaturated, terminal carbon atom carries at least one chlorine or fluorine substituent.

Examples are 1,3,3,3-tetrafluoropropene (HFO-1234ze); 1,1,3,3-tetrafluoropropene; 1,2,3,3,3-pentafluoropropene (HFO-1225ye); 1,1,1-trifluoropropene; 1,1,1,3,3-pentafluoropropene (HFO-1225zc); 1,1,2,3,3-pentafluoropropene (HFO-1225yc); 1-chloro-2,3,3,3- tetrafluoropropene (HFO-1224yd); 1,1,1,2,3-pentafluoropropene (HFO-1225yez); 1-chloro-3,3,3-trifluoropropene (HCFO-1233zd); 1,1,1,4,4,4-hexafluorobut-2-ene (HFO-1336mzz) or mixtures of two or more of these components. Preferred compounds (d1) are hydroolefins selected from the group consisting of trans-1-chloro-3,3,3-trifluoro-propene (HCFO-1233zd(E)), cis-1-chloro-2,3,3,3-tetrafluoropropene (HCFO-1224yd), trans-1,1,1,4,4,4-hexafluorobut-2-ene (HFO-1336mzz(E)), cis-1,1,1,4,4,4-hexafluorobut-2-ene (HFO-1336mzz(Z)), or mixtures of one or more components thereof. Particular preference is given to trans-1-chloro-3,3,3-trifluoropropene (HCFO-1233zd(E)), which surprisingly leads to particularly trouble-free foam qualities on the lower cover layer in the continuous production process.

Examples of hydrocarbon compounds having 4 to 8 carbon atoms (d2) are compounds such as heptane, hexane and isopentane, preferably technical mixtures such as n- and iso-pentane, n- and iso-butane and propane, cycloalkanes such as cyclopentane and/or cyclohexane, and in particular pentane isomers such as n-pentane, isopentane and cyclopentane.

The hydrocarbon compound (d2) preferably contains at least 60 mol %, particularly preferably more than 70 mol % and in particular more than 80 mol % of cycloaliphatic hydrocarbon compounds.

In addition to the blowing agents (d1) and (d2), further physical blowing agents can be used.

Particularly suitable are liquids which are inert to the isocyanates used and have boiling points below 100° C., preferably below 50° C., at atmospheric pressure, so that they evaporate under the influence of the exothermic polyaddition reaction. Examples are ethers such as furan, dimethyl ether and diethyl ether, ketones such as acetone and methyl ethyl ketone, carboxylic acid alkyl esters such as methyl formate, dimethyl oxalate and ethyl acetate and halogenated hydrocarbons such as methylene chloride, dichloromonofluoromethane, difluoromethane, trifluoromethane, difluoroethane, tetrafluoroethane, chlorodifluoroethane, 1,1-Dichloro-2,2,2-trifluoroethane, 2,2-dichloro-2-fluoroethane and heptafluoropropane. Mixtures of these low-boiling liquids with one another and/or with other substituted or unsubstituted hydrocarbons can also be used. The proportion of physical blowing agent that does not fall under the definition of component (d1) or (d2) is preferably less than 30% by weight, particularly preferably less than 15% by weight, more preferably less than 5% by weight., each based on the total weight of the blowing agent component (d1) and (d2) and the other physical blowing agents.

In particular, no further physical blowing agent is used in addition to the blowing agent components (d1) and (d2).

Blowing agents used to produce the polyurethane foams of the present invention also include chemical blowing agents.

These react with isocyanate groups to form carbon dioxide and, in the case of formic acid, carbon dioxide and carbon monoxide. Organic blowing agents are also suitable as chemical blowing agents (d3). carboxylic acids such as B. formic acid, acetic acid, oxalic acid, and other carboxyl-containing compounds with <6 carbon atoms, and water.

In addition to the compounds (dl), preference is given to using no halogenated hydrocarbons as blowing agents.

Water, formic acid-water mixtures or formic acid are preferably used as chemical blowing agents (d3), particularly preferred chemical blowing agents are water or formic acid-water mixtures, in particular water-formic acid mixtures with a formic acid content of >70% by weight. based on blowing agent (d3), which leads to improved top layer adhesion and trouble-free foam surfaces below the lower top layer.

If chemical blowing agents (d3) are used, they are preferably used at less than 2% by weight, based on the total weight of components (b) to (g), preferably at 0.5 to 1.5% by weight.

According to the invention, the molar proportion of halogenated hydrocarbon compounds (d1) is 20 and 60 mol %, preferably 25 to 55 mol % and particularly preferably 30 to 50 mol % and the molar proportion of hydrocarbon compound (d2) is between 40 and 80 mol % , preferably 45 and 75 mol % and particularly preferably 50 to 70 mol %, based in each case on the total content of the blowing agents (d1) and (d2).

The blowing agents (d) are preferably used in amounts such that the free-foam density of the polyisocyanate-based rigid foams of the invention is between 10 and 100 g/l, preferably between 20 and 75 g/I and in particular between 30 and 50 g/l.

In general, the flame retardants known from the prior art can be used as flame retardants (e).

Examples of suitable flame retardants are brominated esters, brominated ethers (Ixol) or brominated alcohols such as dibromoneopentyl alcohol, tribromoneopentyl alcohol and PHT-4-diol, and chlorinated phosphates such as tris-(2-chloroethyl) phosphate, tris-(2-chloropropyl).) phosphate (TCPP), tris(1,3-dichloropropyl) phosphate, tricresyl phosphate, tris(2,3-dibromopropyl) phosphate, tetrakis(2-chloroethyl) ethylene diphosphate, dimethylmethanephosphonate, diethyl diethanolaminomethylphosphonate and commercially available halogenated ones flame retardant polyols.

Diethyl ethanephosphonate (DEEP), triethyl phosphate (TEP), dimethylpropyl phosphonate (DMPP), diphenyl cresyl phosphate (DPK) can be used as liquid flame retardants as further phosphates or phosphonates.

Fa-

Flame retardants with isocyanate-reactive groups are assigned both to the component of the flame retardants (e) and to component (b).

In addition to the flame retardants already mentioned, inorganic or organic flame retardants such as red phosphorus, red phosphorus-containing finishes, aluminum oxide hydrate, antimony trioxide, arsenic oxide, ammonium polyphosphate and calcium sulfate, Blahgra phit or cyanuric acid derivatives, such as.

As melamine, or mixtures of at least two flame retardants, such as. B. ammonium polyphosphates and melamine and optionally corn starch or ammonium polyphosphate, melamine, expandable graphite and optionally aromatic cal polyester for flameproofing of rigid polyurethane foams can be used.

Preferred flame retardants do not contain bromine.

Particularly preferred flame retardants consist of atoms selected from the group consisting of carbon, hydrogen, phosphorus, nitrogen, oxygen and chlorine, more particularly from the group consisting of carbon, hydrogen, phosphorus and chlorine.

Preferred flame retardants have no groups that are reactive with isocyanate groups.

The flame retardants are preferably liquid at room temperature. TCPP, DEEP, TEP, DMPP and DPK and oligomers of halogen-free flame retardants such as Fyrol®PNX (from ICL) and Levagard®2000 (from Lanxess) and/or installable phosphorus-based flame retardants such as Veriquel are particularly preferred®R-100 (from ICL) and Levagard®2100 (from Lanxess), in particular TCPP and TEP, even more preferably TEP, which in continuous processing results in trouble-free foam surfaces below the lower cover layer and in the event of fire for reduced release corrosive fire gases.

In general, the proportion of flame retardant (e) is 1 to 40% by weight, preferably 5 to 30% by weight, particularly preferably 8 to 25% by weight, based on the total weight of components (b) to (G).

If appropriate, further auxiliaries and/or additives (f) can also be added to the reaction mixture for the production of the polyurethane foams according to the invention.

Mention may be made, for example, of surface-active substances, foam stabilizers, cell regulators, fillers, light stabilizers, dyes, pigments, hydrolysis stabilizers, fungistatic and bacteriostatic substances.

As surface-active substances z. B. compounds into consideration, which are used to support the homogenization of the starting materials and may also be suitable for regulating the cell structure of the plastics. Examples which may be mentioned are emulsifiers, such as the sodium salts of castor oil sulfates or of fatty acids, and salts of fatty acids with amines, e.g. B. oleic acid diethylamine, stearic acid diethanolamine, ricinoleic acid diethanolamine, salts of sulfonic acids, z. B. alkali metal or ammonium salts of dodecylbenzene or dinaphthylmethanedisulfonic acid and ricinoleic acid, foam stabilizers such as siloxane-oxalkylene copolymers and other organopolysiloxanes and dimethylpolysiloxanes. Oligomeric acrylates with polyoxyalkylene and fluoroalkane radicals as side groups are also suitable for improving the emulsifying effect, the cell structure and/or stabilizing the foam. The surface-active substances are usually used in amounts of 0.01 to 10 parts by weight, based on 100 parts by weight of component (b).

Customary foam stabilizers, for example those based on silicone, such as siloxane-oxalkylene copolymers and other organopolysiloxanes, can be used as foam stabilizers.

Fillers, in particular fillers with a reinforcing effect, are the usual organic and inorganic fillers, reinforcing agents, weighting agents, agents for improving the abrasion behavior in paints, coating agents, etc. which are known per se.

Specific examples include: inorganic fillers such as silicate minerals, for example sheet silicates such as antigorite, serpentine, hornblende, amphibole, chrysotile and talc, metal oxides such as kaolin, aluminum oxide, titanium oxide and iron oxide, metal salts such as chalk, barite and inorganic pigments such as cadmium sulphide and zinc sulphide, as well as glass and others.

Kaolin (china clay), aluminum silicate and co-precipitates of barium sulfate and aluminum silicate and natural and synthetic fibrous minerals such as wollastonite, metal and in particular glass fibers of various lengths, which can optionally be sized, are preferably used. Examples of suitable organic fillers are: carbon, melamine, colophony, cyclopentadienyl resins and graft polymers and cellulose fibers, polyamide, polyacrylonitrile, polyurethane, polyester fibers based on aromatic and/or aliphatic dicarboxylic acid esters and in particular carbon fibers.

The inorganic and organic fillers can be used individually or as mixtures and are advantageously added to the reaction mixture in amounts of 0.5 to 50% by weight, preferably 1 to 40% by weight, based on the weight of components (a) to (f), although the content of mats, fleece and fabrics made from natural and synthetic fibers can reach values of up to 80% by weight, based on the weight of components (a) to (f).

compounds (g) are preferably substances which are free-flowing at a temperature of 20° C. and an ambient pressure of 1 bar.

Examples of compounds (g) are carboxylic acid esters, such as lower alkanol esters of carboxylic acids used, for example fatty acid ethyl ester or preferably fatty acid methyl ester, such as. B. methyl caproate, methyl caprylate, methyl caprate, methyl laurate, methyl myristate, methyl palmitate, methyl oleate, methyl stearate, methyl linoleate, methyl linoleate and mixtures thereof, particularly preferably biodiesel.

Triglycerides, particularly preferably fats and oils, can also preferably be used as compounds with hydrophobic groups (g), for example triglycerides such as rapeseed oil, olive oil, corn oil, palm oil, pumpkin seed oil, sunflower oil, wheat seed oil, soybean oil, coconut oil, tall oil, cotton seed oil, grape seed oil, apricot seed oil, safflower oil, avocado oil, macadamius oil, pistachio oil, almond oil, linseed oil, sesame oil, hazelnut oil, peanut oil, walnut oil, primula oil, sea buckthorn oil, safflower oil, borage seed oil, black cumin oil, wild rose oil, tallow, and mixtures thereof.

According to the invention, the polyurethane foams are produced by mixing components (a) to (e) and, if present, (f) and (g) to form a reaction mixture.

Premixes can also be made to reduce complexity.

These comprise at least one isocyanate component (A) containing polyisocyanates (a) and a polyol component (B) containing isocyanate-reactive compounds (b). Isocyanate component (A) and polyol component (B) can all or part of the other components (c) to (g) be added in whole or in part, due to the high reactivity of the isocyanates in many cases the components (c) to (g) to Avoidance of side reactions are often added to the polyol component. Blowing agents (d1), in particular, can also be added to the isocyanate component (A). The physical blowing agents (d1) and (d2) are preferably added to the reaction mixture in an extra stream, and the remaining components (d) to (g) of the polyol component (B) are particularly preferably added. The reaction mixture is then allowed to react to form the polyurethane foam. In the context of the present invention, a reaction mixture is the mixture of the isocyanates (a) and the isocyanate-reactive compounds (b) at reaction conversions of less than 90%, based on the isocyanate groups.

The mixing of the components to form the reaction mixture takes place at an isocyanate index of from 240 to 1000, preferably from 240 to 800, preferably from 240 to 600, in particular preferably at 280 to 500 and in particular at 330 to 400. The starting components are mixed at a temperature of from 15 to 90.degree. C., preferably from 20 to 60.degree. C., in particular from 20 to 45.degree. The reaction mixture can be blended by blending in high or low pressure metering machines.

The reaction mixture can, for example, be introduced into a mold for complete reaction.

According to this technology z. B. discontinuous sandwich elements are produced.

The rigid foams according to the invention are preferably produced on continuously operating double-belt systems.

The polyol and isocyanate components are dosed with a high-pressure machine and mixed in a mixing head. Catalysts and/or blowing agents can be metered into the polyol mixture beforehand using separate pumps. The reaction mixture is applied continuously to the lower layer. The bottom layer with the reaction mixture and the top cover layer enter the double belt, in which the reaction mixture foams and hardens. After leaving the double belt, the endless strand is cut to the desired dimensions. In this way, sandwich elements with metallic cover layers or with flexible cover layers can be produced.

The lower and upper cover layers, which can be the same or different, can be flexible or rigid cover layers, which are usually used in the double-belt process.

These include metal top layers such as aluminum or steel, bitumen top layers, paper, nonwovens, plastic sheets such as polystyrene, plastic films such as polyethylene films or wood top layers. The top layers can also be coated, for example with a conventional paint or an adhesion promoter. Cover layers are particularly preferably used which are diffusion-tight with respect to the cell gas of the polyurethane foam.

Such methods are known and are described, for example, in “Plastics Manual, Volume 7, Polyurethane”, Carl Hanser Verlag, 3. Edition 1993, Chapter 6.2.2 or EP 2234732.

Finally, the subject of the present invention is a polyisocyanate-based rigid foam obtainable by a method according to the invention and a polyurethane sandwich element containing such an inventive polyisocyanate-based rigid foam.

An inventive polyisocyanate-based rigid foam is characterized by excellent mechanical properties, in particular excellent compressive strength and outstandingly low thermal conductivities.

In addition, in the production of sandwich elements, in particular in the continuous double-belt process, sandwich elements are obtained with an excellent surface quality of the polyisocyanate-based rigid foam, in particular for the lower cover layer.

The invention is to be illustrated below using examples:

To prepare the reaction mixtures shown in Tables 1, 2 and 4, the following starting materials were used:

polyols:

Polyesterol 1: esterification product of terephthalic acid, oleic acid, diethylene glycol and ethoxylated glycerol having a hydroxyl number of 535 mg KOH/g, a hydroxyl number of 244 mg KOH/g and a weight fraction of oleic acid of 15% in the end product.

This results in a proportion of hydrophobic groups in the total weight of polyesterol 1 of approx. 13.3% by weight, based on the total weight of the polyesterol 1.

Polyesterol 2: Esterification product of phthalic anhydride, diethylene glycol and monoethylene glycol, with a hydroxyl number of 240 mg KOH/g and a weight fraction of 0% oleic acid end product.

Polyesterol 3: esterification product of phthalic anhydride, soybean oil and diethylene glycol with a hydroxyl number of 194 mg KOH/g and a weight fraction of 3.7% fatty acid in the end product.

This results in a proportion of hydrophobic groups in the total weight of polyester 3 of approx. 1% by weight based on the total weight of the polyesterol 3.

Polyester polyol 4: esterification product of phthalic anhydride, glycerol, oleic acid and diethylene glycol with a hydroxyl number of 195 mg KOH/g and a weight fraction of 3.7% oleic acid in the end product.

This results in a proportion of hydrophobic groups in the total weight of polyesterol 4 of approx. 3.3% by weight based on the total weight of the polyesterol 4.

Polyester polyol 5: esterification product of phthalic anhydride, monoethylene glycol and diethylene glycol with a hydroxyl number of 215 mg KOH/g and a weight fraction of 15.8% oleic acid in the end product.

This results in a proportion of hydrophobic groups in the total weight of polyesterol 5 of approx.

14.0% by weight based on the total weight of the polyester 5.

Polyetherol 1: polyethylene glycol with a hydroxyl number of 188 mg KOH/g flame retardant:

TCPP: Tris(2-chloroisopropyl) phosphate with a chlorine content of 32.5% by weight and a phosphorus content of 9.5% by weight. %.

TEP: triethyl phosphate with a phosphorus content of 17 wt. %

Foam Stabilizers:

Tegostab® B 8443: Silicone-containing foam stabilizer from Evonik

Catalysts:

Catalyst A: Trimerization catalyst consisting of 36.2% by weight of potassium formate dissolved in 63.7% by weight of monoethylene glycol

Catalyst B: Catalyst consisting of 23.1% by weight of bis(2-dimethylaminoethyl) ether and 76.9% by weight of dipropylene glycol.

Chemical blowing agents:

Amasil 85%: 85% by weight formic acid solution in water

Physical Blowing Agents:

Pentane S 80/20: Mixture of 80% by weight n-pentane and 20% by weight % isopentane

Cyclopentane 70: Mixture of 70 wt. % cyclopentane and 30 wt. % isopentane

yclopentane 95: Mixture of 95 wt. % cyclopentane and 5 wt. % isopentane

Solstice® LBA: 1-chloro-3,3,3-trifluoropropene from Honeywell

Opteon™ 1100: (Z)-1,1,1,4,4,4-hexafluoro-2-butene from Chemours

Propellant mixture 1: Mixture of 55.88 wt. % cyclopentane 70 and 44.12 wt. % Solstice® LBA leads to a blowing agent mixture containing approx. 70 mol % cyclopentane 70.

183 Propellant mixture 2: Mixture of 56.12 wt. % pentane S 80/20 and 43.88 wt. % Solstice® LBA leads to a blowing agent mixture containing approx. 70 mol % pentane S 80/20.

Isocyanates:

Lupranat® M50: polymeric methylenediphenyl diisocyanate (PMDI) from BASF, with a viscosity of approx. 550 mP*s at 25° C.

The polyol components shown in Tables 1, 2 and 4 were produced from the above-mentioned starting materials and converted in the laboratory and on a high-pressure machine in a continuous double-belt process.

Laboratory foaming to set identical densities and setting times (gel times):

The polyol components shown in Table 1 were adjusted to identical setting times of 53 s±2 s and cup foam densities of 44 kg/m3±2 kg/m3 by varying the physical blowing agents and catalyst B.

The amount of catalyst A was chosen so that the finished foams of all settings contained identical concentrations.

The polyol components adjusted in this way were reacted with Lupranat® M50 in such a mixing ratio that the index of all adjustments was 330±10.

In this way, 80 g of reaction mixture was reacted in a paper cup by intensively mixing the mixture for 8 seconds with a laboratory stirrer at 1400 rpm.

The polyol components shown in Table 2 were adjusted to identical setting times of 53 s±2 s and cup foam densities of 42 kg/m3±2 kg/m3 by varying the physical blowing agents and catalyst B.

The amount of catalyst A was chosen so that the finished foams of all settings contained identical concentrations.

The polyol components adjusted in this way were reacted with Lupranat® M50 in such a mixing ratio that the index of all adjustments was 330±10.

In this way, 80 g of reaction mixture was reacted in a paper cup by intensively mixing the mixture for 8 seconds with a laboratory stirrer at 1400 rpm.

The polyol components shown in Table 3 were adjusted to identical setting times of 53 s±2 s and cup foam densities of 42 kg/m3±2 kg/m3 by varying the physical blowing agents and catalyst B.

The amount of catalyst A was chosen so that the finished foams of all settings contained identical concentrations.

The polyol components adjusted in this way were reacted with Lupranat® M50 in such a mixing ratio that the index of all adjustments was 210±10.

In this way, 80 g of reaction mixture was reacted in a paper cup by intensively mixing the mixture for 8 seconds with a laboratory stirrer at 1400 rpm.

The reaction mixtures adjusted in this way to comparable densities and setting times were then used to produce rigid foam blocks, from which test specimens for thermal conductivity and compressive strength measurements were taken.

To produce the foam blocks for the thermal conductivity measurements, 450 g of the reaction mixture was reacted in a paper cup by intensively mixing the mixture for 6 seconds with a laboratory stirrer at 1400 rpm.

The reaction mixture was then transferred to a box mold with the dimensions 150 mm×120 mm×120 mm, which was open at the top.

The specimens for the thermal conductivity measurements with the dimensions 200 m×200 m×30 mm were always removed from the center of the foam block in the direction of foam rise.

The thermal conductivity was measured with a thermal conductivity meter I-Meter EP500e from the company “Lambda Messtechnik GmbH Dresden” at a mean temperature of 23° C. The thermal conductivity values given in Tables 1 and 2 are mean values of a double determination of two test specimens from two different but identically manufactured foam blocks.

In addition, 9 test specimens measuring 50 m×50 m×50 mm were taken from the same foam blocks to determine the compressive strength according to DIN EN 826.

The removal was always the same here.

Of the 9 test specimens, 3 test specimens were rotated in such a way that the test took place against the direction of rise of the foam (top).

Of the 9 test specimens, 3 test specimens were rotated in such a way that the test took place perpendicular to the direction of rise of the foam (in the X direction). Of the 9 test specimens, 3 test specimens were rotated in such a way that the test took place perpendicular to the direction of rise of the foam (in the Y direction).

The measured 9 compressive strengths were then averaged and given as values (compressive strength 3D) in Tables 1 and 2.

Table 1: Laboratory tests with Cydopentan 70/Solstice® LBA mixtures <img file=“imgf000029_0001.tif” frnum=“0001” he=“42” id=“imgf000029_0001” img-content=“table” img-format=“tif” inline=“no” orientation=“portrait” pgnum=“0001” wi=“172”/>

E: According to the invention, X: Used

Table 2: Laboratory tests with Pentane S 80/20/Solstice® LBA mixtures <img file=“imgf000030_0002.tif” frnum=“0001” he=“124” id=“imgf000030_0002” img- content=“table” img-format=“tif” inline=“no” orientation=“portrait” pgnum=“0003” wi=“141”/>

E: According to the invention, X: Used

Table 3: Laboratory tests with pentane S 80/20/Solstice® LBA mixtures at index 210 <img file=“imgf000032_0001.tif” frnum=“0001” he=“92” id=“imgf000032_0001” img-content=“table” img-format=“tif” inline=“no” orientation=“portrait” pgnum=“0006” wi=“173”/>

X; Used

Due to the lower thermal conductivity of the Solstice® LBA blowing agent compared to

Cyclopentane 70 and Pentane S 80/20, it is not surprising that the foams produced in the laboratory with blowing agent mixtures 1 and 2 also have a lower thermal conductivity.

Surprisingly, however, it is found that the use of polyol components which have a lower content of hydrophobic groups in components (b)-(g) results in a significantly reduced thermal conductivity and a significantly improved compressive strength of the laboratory foams.

Foaming of the polyol component according to the invention from example 13 with a reduced index of 210 (example 19) leads to a significant increase in thermal conductivity and a significant reduction in the compressive strength of the foam compared to the examples according to the invention.

Continuous production of sandwich elements using the double-belt process:

In addition to the laboratory foaming, 80 mm thick composite elements were manufactured using the double-belt process.

For the production, the polyol components listed below, which had been heated to 20±1° C., were reacted with Lupranat® M50, which had also been heated to 20±1° C.

The amount of Lupranat® M50 was always chosen so that all of the rigid foams produced had an isocyanate index of 345±10.

To produce the composite elements, an aluminum foil 0.05 mm thick heated to 35±2° C. and a 0.5 mm thick aluminum sheet coated on both sides, heated to 40±2° C., served as the lower cover layer.

Both top layers are industry standards and are also used in the conventional continuous manufacturing process of sandwich panels.

The temperature of the double band was always 60±1° C.

To produce the 80 mm thick composite elements, the amount of catalyst B and the physical blowing agent was selected so that the gel time of the reaction mixture was exactly 28 seconds and the contact time of the reaction mixture with the top belt was exactly 23 seconds and the foam had an overall density of 38.0±1.5 g/l.

To determine the thermal conductivities, compressive strengths and foam surfaces, test specimens with a length of 2.0 m and a width of 1.25 m were taken after successful adjustment of the foaming parameters, from which the test specimens required for the tests were always taken at identical points.

Determination of the compressive strength of the sandwich foams:

After storage for 24 hours in a standard climate, further test bodies measuring 100 mm×100 mm×sandwich thickness were removed from the test specimens using a band saw.

The test specimens were taken at identical points, distributed across the width of the element (left, middle, right) and the compressive strength of the foam was determined according to the sandwich standard DIN EN ISO 14509-A.2 according to EN 826.

Determination of the thermal conductivities of the sandwich foams:

After storage for 24 hours in a standard climate, further test bodies measuring 200 mm×200 mm×30 mm were removed from the test specimens.

The removal took place in the middle of the sandwich element thickness and the sandwich element width.

The thermal conductivity was measured with a thermal conductivity meter I-Meter EP500e from Lambda Messtechnik GmbH Dresden at a mean temperature of 23° C. The thermal conductivity values given in Table 5 are mean values of a double determination of two test specimens

Evaluation of the foam surface after tearing off the lower cover layers:

After mechanical removal of the aluminum foil and the aluminum sheets, to which the liquid reaction mixture is applied directly using the double-belt process (lower cover layer)

the foam surfaces were assessed and evaluated visually, with grade 1 representing the best foam surface and grade 5 representing the worst foam surface:

Table 4: Optical assessment of the foam quality <img file=“imgf000034_0001.tif” frnum=“0001” he=“43” id=“imgf000034_0001” img-content=“table” img-format=“tif” inline=“no” orientation=“portrait” pgnum=“0007” wi=“152”/>

Table 5: Double belt tests <img file=“imgf000034_0002.tif” frnum=“0001” he=“165” id=“imgf000034_0002” img-content=“table” img-format=“tif” inline=“no” orientation=“portrait” pgnum=“0008” wi=“161”/>

E: According to the Invention

When using the same amounts of the identical blowing agent mixture, it is found that when using the polyol components according to the invention with a low proportion of hydrophobic groups in components (b)-(g) (Examples 20, 26 and 30), even in the double-belt process, there is a significantly reduced thermal conductivity and increased compressive strength of the foams produced, compared to polyol components with an increased proportion of hydrophobic groups in components (b)-(g) (Example 27).

Surprisingly, however, the polyol components with a low proportion of hydrophobic groups in components (b)-(g) show no continuous improvement in thermal conductivity with increasingly higher proportions of halogenated olefins compared to cyclopentane 95.

There is a minimum in thermal conductivity when the molar proportion of the halogenated olefins to the molar proportion of cyclopentane 95 is between 20 and 55 mol %.

A further increase in the molar fraction of the halogenated olefins to well above 70 mol %, preferably 65 mol %, more preferably 60 mol % and in particular 55 mol %, in combination with the polyol components of the invention surprisingly leads to an increase in the thermal conductivities manufactured foams.

In addition, it is found that a higher proportion of both halogenated olefins above 70 mol % causes the foam qualities to deteriorate on the underside (Examples 22, 23 and 25).

Also in combination with pentane S80/20, the polyol components with a low proportion of hydrophobic groups in components (b)-(g) show a significantly improved thermal conductivity compared to the polyol components not according to the invention (example 28 vs.

Example 29).

In comparison with the reaction mixtures not according to the invention, however, the use of pentane S 80/20 leads to significantly poorer thermal conductivities and foam qualities on the underside of the various top layers (Example 28).

1. A process for producing rigid polyisocyanurate foam, wherein
a) aromatic polyisocyanate,
b) isocyanate-reactive compounds comprising at least one polyetherol (b1) and/or polyesterol (b2), wherein the number-average content of isocyanate-reactive hydrogen atoms of components (b1) and (b2) is at least 1.7,
c) catalyst,
d) blowing agents,
e) flame retardants,
f) optionally auxiliary and additional substances, and
g) optionally compounds having aliphatic hydrophobic groups and not falling under the definition of compounds (a) to (f)
are mixed to afford a reaction mixture and allowed to cure to afford a rigid polyisocyanurate foam, wherein
blowing agent (d) comprises at least one aliphatic halogenated hydrocarbon compound (d1) composed of 2 to 5 carbon atoms, at least one hydrogen atom and at least one fluorine and/or chlorine atom and compound (d1) comprises at least one carbon-carbon double bond, and a hydrocarbon compound having 4 to 8 carbon atoms (d2) and the molar proportion of halogenated hydrocarbon compound (d1) is between 20 and 60 mol % and the molar proportion of hydrocarbon compound (d2) is between 40 and 80 mol %, in each case based on the total content of the blowing agents (d1) and (d2),
and components (b) to (g) may comprise compounds having aliphatic hydrophobic groups and the content of aliphatic hydrophobic groups, based on the total weight of components (b) to (f), is 0% to 4.0% by weight and
the mixing to afford the reaction mixture is carried out at an isocyanate index of at least 180.

2. The process according to claim 1, wherein the hydrocarbon compound (d2) comprises at least 60 mol % of cycloaliphatic hydrocarbon compounds based on the total weight of the hydrocarbon compound (d2).

3. The process according to claim 1, wherein the hydrocarbon compound (d2) is selected from the group consisting of isomers of pentane.

4. The process according to claim 1, wherein the halogenated hydrocarbon compound (d1) is 1-chloro-3,3,3-trifluoropropene.

5. The process according to claim 1, wherein the blowing agent comprises formic acid.

6. The process according to claim 1, wherein the catalyst (c) comprises at least one amine catalyst having a tertiary amine group and at least one ammonium or alkali metal carboxylate catalyst.

7. The process according to claim 6, wherein the at least one amine catalyst having a tertiary amine group is selected from the group consisting of pentamethyldiethylenetriamine and bis(2-dimethylaminoethyl) ether and the at least one alkali metal carboxylate catalyst is selected from the group consisting of potassium formate, potassium acetate and potassium 2-ethylhexanoate.

8. The process according to claim 1, wherein the compounds having at least one isocyanate-reactive hydrogen atom (b) comprise 0% to 30% by weight of polyetherol (b1) and 70% to 100% by weight of polyesterol (b2), in each case based on the total weight of polyetherol (b1) and polyesterol (b2).

9. The process according to claim 1, wherein the polyether polyol (b1) is the reaction product of a starter molecule having a functionality of 2 to 4 with alkylene oxide, comprising ethylene oxide, and has a hydroxyl number of 150 to 300 mg KOH/g.

10. The process according to claim 1, wherein the polyester polyol (b2) was obtained using aromatic dicarboxylic acid or derivatives thereof.

11. The process according to claim 1, wherein the flame retardants (e) employed are exclusively halogen-free flame retardants.

12. The process according to claim 1, wherein the reaction mixture is applied to a continuously moving outer layer.

13. The process according to claim 12, wherein the application of the reaction mixture onto a continuously moving outer layer is carried out on a double belt line for production of sandwich elements.

14. The process according to claim 1, wherein premixtures comprising an isocyanate component (A) comprising aromatic polyisocyanate (a) and a polyol component (B) comprising isocyanate-reactive compounds (b) are employed in the production of the reaction mixture and all or some of the further components (c) to (g) are added to one of the components (A) or (B) in whole or in part.

15. The process according to claim 1, wherein physical blowing agents (d1) and (d2) are added to the reaction mixture in an extra stream.

16. A rigid polyisocyanurate foam obtainable by a process according to claim 1.
